(19) United States
(12) Patent Application Publication
(10) Pub. No.: US 2012/0166609 A1
(43) Pub. Date: Jun. 28, 2012

(54) METHOD FOR PROVIDING DEVICE-SPECIFIC INFORMATION OF A FIELD DEVICE OF AUTOMATION TECHNOLOGY AND/OR METHOD FOR SERVICING A FIELD DEVICE

(75) Inventors: Olga Lux, Karlsruhe (DE); Thomas Bednasch, Mannheim (DE)

(73) Assignee: CodeWrights GmbH, Karlsruhe (DE)

(21) Appl. No.: 13/330,870

(22) Filed: Dec. 20, 2011

(30) Foreign Application Priority Data
Dec. 22, 2010 (DE) 10 2010 063.854.4

(51) Int. Cl. G06F 15/16

(52) U.S. Cl. 709/223

(57) ABSTRACT

A method for providing device-specific information of a field device of automation technology and/or to a method for servicing a field device, wherein a device description comprehensively describing the field device is integrated in a web server in the field device, wherein at least one part of the device description describing the field device is compiled/interpreted in a field device specific, software code in a web browser, which is connectable with the field device, and wherein, based on the field device specific, software code, there are presented on the web browser dynamically produced, device-specific web pages, via which operating personnel are provided device-specific information, and/or via which the field device is serviced by the operating personnel.

### TECHNICAL FIELD

The invention relates to a method for providing device-specific information of a field device of automation technology and/or to a method for servicing a field device.

### BACKGROUND DISCUSSION

In process- as well as in manufacturing-automation technology, field devices are often applied, which serve for registering and/or influencing process variables. Serving for registering process variables are measuring devices, such as, for example, fill level measuring devices, flow measuring devices, pressure- and temperature measuring devices, pH-measuring devices, conductivity measuring devices, etc., which register the corresponding process variables, fill level, flow, pressure, temperature, pH-value, or conductivity. Used for influencing process variables are actuators, such as valves or pumps, via which e.g. the flow of a liquid in a pipeline or the fill level of a medium in a container is changed. Thus, in connection with the invention, the term ‘field devices’ refers to all types of measuring devices and actuators.

In connection with the invention, the term ‘field devices’ thus refers to all devices, which are applied near to the process and which deliver, or process, process relevant information. Besides the earlier named measuring devices/sensors and actuators, also referred to as field devices are generally any units, which are connected directly to a fieldbus and which serve for communication with the superordinated unit. Thus, units such as remote I/Os, gateways, linking devices and wireless adapter, or radio adapters are also field devices. A large number of such field devices are available from the Endress Hauser group of companies.

The integration of field devices in configuration- or management systems and, respectively, operating tools occurs via device descriptions, which enable that the superordinated control units or servicing devices can detect and interpret the data delivered from the field devices. Device descriptions for each field device type, or for each field device type in different applications, are, as a rule, provided by the respective device manufacturer. In order that the field devices can be integrated in different communication systems, different device descriptions must be created for the different data bus systems.

Besides fieldbus systems, which are designed for the special needs of automation technology, especially process automation technology, in increasing measure, TCP/IP protocols are being applied for servicing field devices. Becoming ever more important in automation technology is the industrial Ethernet. Examples for industrial Ethernet are: HSE, ControlNet, Industrial IP, Profi-Net, HART UDP/TCP, . . . . Field devices, which are connected with a superordinated control unit via industrial Ethernet, make use of a web server. The web server enables online servicing of a field device by means of a Web browser connected with the bus system. The terminology, servicing field devices, means, in connection with the invention to be described below, especially the parametering and/or configuration of field devices. Servicing includes, however, also performing a diagnosis of the field device or in the simplest case the representation, on a display, of information delivered from the field device.

### SUMMARY OF THE INVENTION

An object of the invention is to have available, for the purpose of servicing a field device, in each case, the current version the device description of the field device.

The object is achieved by a method having method steps as follows:
a device description comprehensively describing the field device is integrated in a web server in the field device;
at least one part of the device description describing the field device is compiled/interpreted in a field device specific, software code in a web browser, which is connectable with the field device; and
based on the field device specific, software code, there are presented on the web browser dynamically produced, device-specific web pages, via which operating personnel are provided device-specific information, and/or via which the field device is serviced by the operating personnel.

The solution of the invention permits the servicing of the field devices by means of usual Web technologies, thus by means of standard Web technologies. The solution is distinguished by the following advantages:
a standard web browser can be used;
the device description is always current; and
additional setups are not required.

An advantageous further development of the method of the invention provides that interpretation in the web browser occurs by means of a plug-in based technology, such as Flash, Java or Silverlight.

Preferably, the interpretation in the web browser occurs by means of a proprietary plug-in (a plug-in developed by the manufacturer of the field device), which uses an SDC-625 core. The SDC-625 core is a software component, which can interpret an electronic device description. This software component is installed into an existing software component, in order, therewith, to be able to on access components of an electronic device description, especially menus, variables, etc.

Furthermore, an advantageous embodiment of the method of the invention provides that the respectively required plug-in is stored in the field device and subsequently is provided by the field device.

Especially advantageously is the following embodiment of the method of the invention, which is characterized by method steps as follows:
the web browser is started;
the start page is displayed on the web browser;
connection to the selected field device is established;
the plug-in stored, in given cases, in the field device is down loaded into the web browser;
the device description stored in the field device is likewise download into the web browser; and
device-specific web pages, which contain device-specific information and are dynamically produced on the web browser based on the field device specific, software code, are provided for the operating personnel and/or the field device is serviced by the operating personnel via the dynamically produced, device-specific web pages.

Moreover, it is provided that, for the case in which the field device is integrated in a network composed of a plurality of field devices connected with one another via a data bus, the field devices integrated in the network are displayed on the start page, so that one of the field devices provided for information display or servicing can be selected by the the operating personnel.

As already presented above, the field device is preferably parametered or configured via the servicing process. Alternatively, a diagnosis is performed on the field device via the servicing process. An option, moreover, is the representation of device-specific information concerning the field device. Of course, the definitions set-forth in the introduction of the description regarding the solution of the invention and its advantageous embodiments likewise hold.

### BRIEF DESCRIPTION OF THE DRAWINGS

FIG. 1 is a network with a servicing device.

FIG. 2 shows a flow diagram describing a preferred embodiment of the method of the invention.

### DETAILED DESCRIPTION IN CONJUNCTION WITH THE DRAWINGS

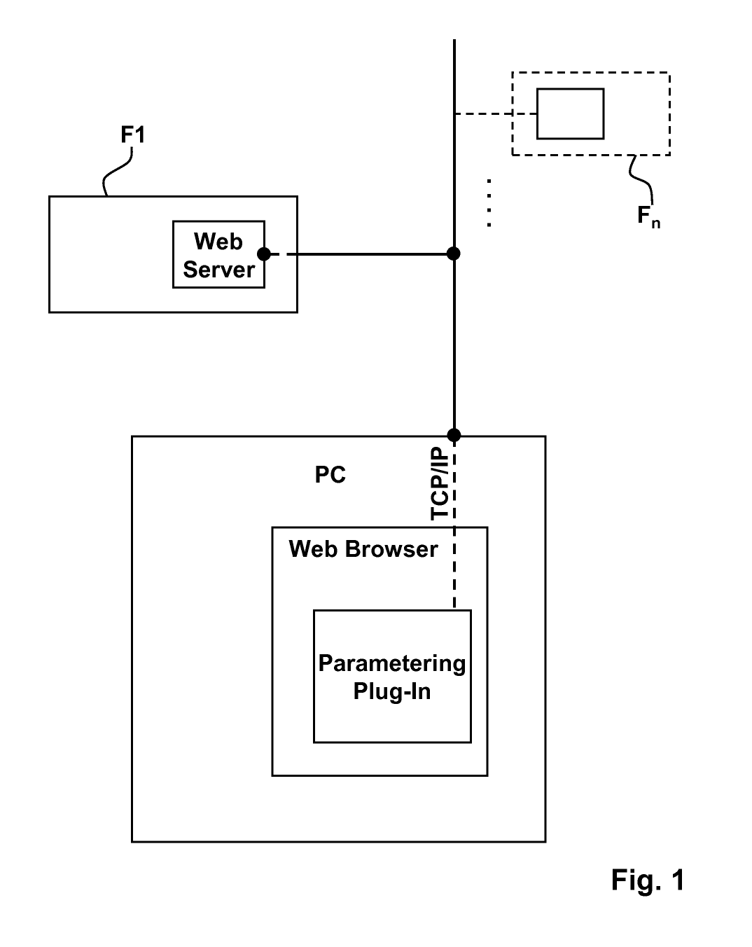

The method of the invention for providing device-specific information of a field device F1 of automation technology and/or for servicing a field device F1 will now be explained in greater detail based on FIG. 1. Shown in FIG. 1 is a PC, and a plurality of field devices F1, Fn, which communicate with one another via the Internet-, or intranet, protocol TCP/IP. Integrated in a web server WS in field device F1 is a device description EDD1 comprehensively describing the field device F1. Via a web browser WB, which, in the shown case, is integrated in the PC and which is connectable with the field device F1, at least one part of the device description EDD1 describing the field device F1 is compiled/interpreted in a field device specific, software code. Based on the field device specific, software code, there are presented on the web browser WB dynamically produced, device-specific web pages, via which the operating personnel are provided with device-specific information in real time. Alternatively, the field device F1 can be serviced by the operating personnel from the web browser WB.

The interpretation, or the compiling, occurs in the web browser WB by means of a plug-in based technology, such as Flash, Java or Silverlight. Alternatively, the interpretation, or the compiling, occurs in the web browser by means of a proprietary plug-in, which uses an SDC-625 core. The SDC-625 core is a software component, which can interpret an electronic device description EDD. This software component is installed in an existing software component, in order to be able to access therewith an electronic device description EDD, especially menus, variables, etc. In the illustrated case, the required plug-in is stored in the field device F1 and provided by the field device F1.

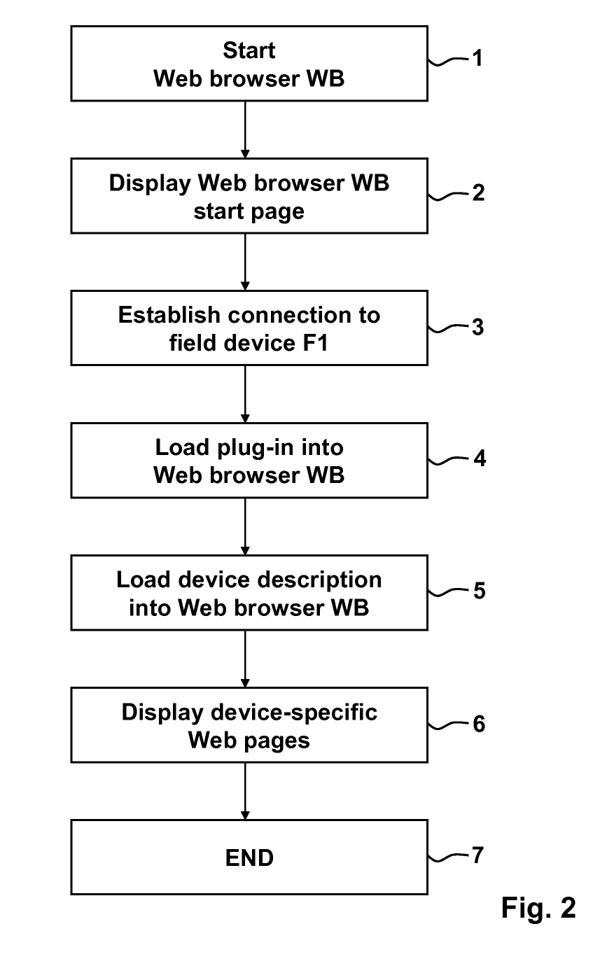

At program point 1, in FIG. 2, the web browser WB is started. At program point 2, the start page is displayed on the web browser WE. At program point 3, the connection to the selected field device F1 is established. If a plurality of field devices F1, Fn are present, then the opportunity is provided for the selection of the desired field device F1. At program point 5, the plug-in usually stored in the web browser WB is downloaded into the field device F1. The device description EDD1 likewise stored in the field device F1 is downloaded into the web browser WE at program point 5. This downloading occurs either automatically or after being required by the operating personnel. Based on the field device specific, software code, provided for operating personnel on the web browser WE at program point 6 are dynamically produced, device-specific web pages, which include device-specific information. Alternatively, the field device F1 is serviced by the operating personnel via the dynamically produced, device-specific web pages. The program ends at program point 7.

1-8. (canceled)

9. A method for providing device-specific information of a field device of automation technology and/or method for servicing a field device, comprising the steps of:
a device description completely describing the field device is integrated in a web server in the field device;
compiling/interpreting at least one part of the device description describing the field device in a field device specific software code in a web browser, which is connectable with the field device;
the interpretation in the web browser occurs by means of a proprietary plug-in, which uses a software component interpreting the electronic device description; and
based on the field device specific software code, there are presented on the web browser dynamically produced, device-specific web pages, via which operating personnel are provided device-specific information, and/or via which the field device is serviced by the operating personnel.

10. The method as claimed in claim 9, wherein:
the interpretation in the web browser occurs by means of a plug-in based technology, such as Flash, Java or Silverlight.

11. The method as claimed in claim 9, wherein:
a proprietary plug-in comprises a SDC625 core.

12. The method as claimed in claim 9, wherein:
in each case, the required plug-in in the field device is stored.

13. The method as claimed in claim 9, wherein:
the web browser is started;
the start page is displayed on the web browser;
connection to the selected field device is established;
the plug-in stored, in given cases, in the field device is downloaded into the web browser;
the device description stored in the field device is automatically downloaded in the web browser; and
device-specific web pages, which contain device-specific information and are dynamically produced on the web browser based on the field device specific, software code, are provided for the operating personnel and/or the field device is serviced by the operating personnel via the dynamically produced, device-specific web pages.

14. The method as claimed in claim 9, wherein:
for the case in which the field device is integrated in a network composed of a plurality of field devices connected with one another via a data bus, the field devices integrated in the network are displayed on the start page, so that one of the field devices provided for information display or servicing can be selected.

15. The method as claimed in claim 9, wherein:
the field device is parametered or configured via the servicing process.

16. The method as claimed in claim 9, wherein:
a diagnosis is performed on the field device via the servicing process.
